(19) United States
(12) Patent Application Publication
(10) Pub. No.: US 2007/0043681 A1
(43) Pub. Date: Feb. 22, 2007

(54) ONLINE TRANSACTIONS SYSTEMS AND METHODS

(76) Inventors: George Frederick Morgan, London (GB); Alexander John Mercer, Dunfermline (GB); Kevin Grant Watkins, Essex (GB)

Correspondence Address: STANDLEY LAW GROUP LLP, 495 METRO PLACE SOUTH, SUITE 210, DUBLIN, OH, 43017, US

(21) Appl. No.: 11/463,358

(22) Filed: Aug. 9, 2006

(30) Foreign Application Priority Data
Aug. 9, 2005 (GB) 0516357.1

(51) Int. Cl. G06Q 99/00

(52) U.S. Cl. 705/67

(57) ABSTRACT

Embodiments of the present invention relate to an online transaction method enacted between a first party and a second party, for example a customer and a bank respectively. The method of the embodiment includes the steps of the first party transmitting a transaction request comprising transaction details and the second party receiving the transaction request and generating, for the first party, an authentication request, comprising transaction details and challenge data. In order to increase the security of the overall transaction, the authentication request is adapted so that it is difficult for an automated process to use or modify information therein to generate a replacement authentication request. Such a method finds application in reducing the potential for a man-in-the-middle attack, wherein an intermediate, subversive process can behave as a legitimate second party in order to steal money from the first party.

### CROSS-REFERENCE TO RELATED APPLICATIONS

The present application claims a right of priority under 35 USC §119 from Great Britain patent application 0516357.1, filed 9 Aug. 2005, the content of which is incorporated by reference as if fully recited herein.

### FIELD OF THE INVENTION

The present invention relates to online transaction systems and methods and, in particular, but not exclusively, to online secure transaction systems and methods that use challenge/response procedures across a network, for example the Internet.

### BACKGROUND OF THE INVENTION

As the Internet, and in particular the World Wide Web (WWW) Internet service, becomes a more widely acceptable medium for enacting online financial transactions, commercial organizations and financial institutions such as banks (collectively referred to herein as ‘service providers’) are having to develop increasingly secure systems and procedures in order to protect the service providers' and their customers' interests from fraudsters who are intent on stealing money, sensitive information and customer identities.

While fraudsters do attack the service providers directly, the service providers typically invest a huge amount of money on security infrastructure and fraud countermeasures that can deter even the most accomplished fraudsters. However, it remains a fact that customers do not always share the knowledge, the desire or the financial resources necessary to maintain such high degrees of security. Accordingly, it is not uncommon for fraudsters to concentrate on attacking the systems that customers use for interacting with service provider systems.

By way of background explanation, an exemplary online transaction between a customer and a service provider—in this example a bank—will now be described with reference to the diagram in FIG. 1.

According to FIG. 1, a system for enacting an online banking transaction is distributed in general across a customer domain 10 and a banking domain 11, which are connected via a network 12 such as the Internet, a LAN or a wireless network. The customer domain 10 includes an access device such as a customer personal computer (PC) 13 and a two-factor authentication device. In the example provided, the two-factor authentication device comprises a customer token 14, such as ‘chip and PIN’ credit or charge card, and a token reader 15. Other kinds of customer access device, for example ‘smart phones’ or personal digital assistants (PDAs), and other kinds of two-factor authentication device, could equally be used.

Two-factor authentication security is an improvement over the currently more widespread use of Personal Identification Number (PIN) and password security. A disadvantage of PIN and password security, even if only a part of each is transferred in any single transaction, is that both can be elicited from a customer by various techniques, including by simply contacting the customer, pretending to be a banking official and asking for the information, or by using known computer-based phishing and spyware attacks, which typically result from a customer unwittingly executing on their computer a respective piece of subversive software code. Once a fraudster has the information, he can use it to access online accounts and execute fraudulent transactions using the identity of the customer.

Typically, a token 14 and token reader 15 can generate apparently random one time passwords, for example for login purposes, or can be used in Challenge/Response (C/R) mode. In C/R mode, a first value (the challenge) is entered into the token, and the token generates and displays a second value (the response) that is cryptographically derived from the challenge and other variable information (for example, keys, time, sequence numbers etc.). When the challenge value has been derived from a transaction (for example, the challenge may be a hash of the transaction details), the response is a form of electronic signature on that transaction. While a customer can still be fooled into giving up their secret information, a fraudster would also need access to the token and the token reader in order to fool the service provider, which is far less easily achieved.

The banking domain 11 typically contains an online banking server 16, which is able to process online customer transactions received via the network 12.

An exemplary online transaction, between a customer and their bank will now be described with reference to the numbered steps shown in FIG. 1.

In a first step 100, using an Internet browser process running on the PC 13, the customer transmits a request for the login page of their online bank website. In step 103, the banking server 16 receives the request and returns the login page to the customer. The customer, in step 106, inserts his token 14 into the token reader, places the token reader 15 in login mode in a known way and, using a numeric keypad of the reader, enters a PIN number. In response, in step 109, the reader 15 generates a unique pass-code; the access information. In step 112, the customer enters their customer identification details and the unique pass-code into the login page and submits the login page to the banking server 16. In response to receiving the access information, assuming the information is first verified by the banking server 16, in step 115 the banking server provides access to, and services associated with, bank accounts registered to the customer.

In step 118, the customer using one of the provided services generates and sends a transaction request, for example, to transfer 300 dollars to a friend, David. In step 121, the banking server 16 receives the request and, in order to validate the request, sends a transaction summary and challenge to the customer to, again, verify that the party requesting the transaction is the customer and not someone who has intervened in or ‘hijacked’ the transaction after the customer had logged in. An exemplary transaction summary and challenge is illustrated in the diagram in FIG. 2A. The transaction summary and challenge 200 in FIG. 2A identifies an account 205 “Customer” from which the payment should be taken, an account 210 “David” to which the payment should be made, a payment amount 215 “$300”, a payment date 225 “Today”, a payment reference or comment 220 “Fund transfer to David” and challenge data 230 “46071234”, which in this example is derived from a hash of the transaction information. In step 124, the customer receives the transaction summary and challenge, places the token reader 15 into C/R mode and, using the keypad of the token reader, he enters the received challenge data “46071234”. In response, in step 127, the token reader 15 generates a response to the challenge and, in step 130, the customer submits the response to the banking server. The response is typically another number or an alphanumeric string. In step 133, the banking server 16 receives the response and, assuming that there are sufficient cleared funds and that the response is valid, which it will be since it was generated using two-factor authentication, executes the transaction to transfer 300 dollars to the bank account belonging to David. Finally, in step 136, the banking server 16 sends a transaction receipt message to the customer. The receipt typically includes confirmation that the transaction, including a copy of the transaction details, has been executed.

In arriving at the present invention, the present applicant has appreciated that while the use of two-factor authentication procedures improves the security of online transactions, there remain a number of ways of subverting such online transactions.

Many fraudulent online attacks are known and well documented. Aspects and embodiments of the present invention relate to a certain class of attacks, which is sometimes referred to as a man-in-the-middle (MITM) attack.

A MITM attack is an attack in which a fraudster is able to read, insert and modify at will, messages between two parties without either party knowing that the communications path between them has been compromised. In order to implement the attack the attacker, which will typically comprise a software process rather than a person as such, must be able to observe and intercept messages going between the two ‘victims’.

One way of establishing a MITM attack is by using a so-called Trojan horse, or simply Trojan, attack.

A Trojan is a piece of executable software that portrays itself as something other than what it is at the point of execution. A Trojan is typically sent by someone—for example a fraudster—or carried by another program and may arrive in the form of a joke program or software of some sort, which may be attached to an apparently-innocuous email. In general, the malicious functionality of a Trojan may be anything undesirable for a computer user, including data destruction or compromising a system by providing a means for another computer to gain access, thus bypassing normal access controls.

In order to subvert an online transaction, for example by facilitating a MITM attack, the presence of a Trojan would typically need to remain unknown to the customer on whose computer it was executed. An example of a potential MITM attack will now be described with reference to the system diagram in FIG. 3.

According to FIG. 3, a system for enacting an online banking transaction comprises a customer domain 30 and a banking domain 31, which are connected via a network 32 such as the Internet, in a similar fashion to the system in FIG. 1. The customer domain 30 includes a customer personal computer (PC) 33, a customer token 34, such as ‘chip and PIN’ credit or charge card, and a token reader 35. The combination of the token and token reader again provides an enhanced two-factor authentication security. The customer domain includes, in this example, a MITM process 37, which typically resides unknown to the customer as a software program on their PC 33. The MITM process 37 is, for reasons of clarity only, illustrated in FIG. 3 as being separate from the PC 33.

The banking domain 31 contains an online banking server 36, which is able to process online banking transactions, as before.

An exemplary online banking transaction, which is subverted by a MITM attack, will now be described with reference to the numbered steps shown in FIG. 3.

In a first step 300, the customer transmits a request for the login page of their online bank website. In this example, MITM process 37 relays the request content to the banking server as if the MITM process had made the request. In step 303, the banking server returns the login page to the MITM process, and the MITM process relays the login page to the customer. The customer, in step 306, inserts his token 34 into the token reader 35, places the token reader in login mode and, using a numeric keypad of the reader, he enters a PIN number. In response, in step 309, the reader 35 generates a unique pass-code. In step 312, the customer enters their customer identification details and the unique pass-code into the login page and submits the login page to the banking server 36. Again, the MITM process 37 relays the login information to the banking server 36 as if the MITM process were the customer. In response, assuming the information is verified by the banking server 36, in step 315 the banking server 36 provides access to, and services associated with, bank accounts registered to the customer. In effect, the services are provided via the MITM process 37, which simply relays respective user interface screens to the customer.

In step 318, the customer generates and sends a transaction request to transfer 300 dollars to the friend, David. In step 321, the MITM process 37 intercepts the request, modifies the request by substituting new recipient and amount details in place of the genuine details, and forwards on the modified request to the banking server 36. For example the modified request might be to send 10,000 dollars to a bank account from where, ultimately, the funds can be withdrawn by the fraudster. In step 324, the banking server 36 receives the modified request and, in order to validate the request, sends a transaction summary and challenge to the customer to, again, verify that the party requesting the transaction is the customer and not someone who has intervened in or ‘hijacked’ the transaction after the customer had logged in. FIG. 2B illustrates the transaction summary and challenge 235 sent by the banking server 36. The transaction summary and challenge 235 identifies an account 240 “Customer” from which the payment should be taken, an account 245 “Fraudster” to which the payment should be made, a payment amount 250 “$10,000”, a payment date 255 “Today”, a payment reference or comment 260 “Fund payment to Fraudster” and challenge data 265 “12340987”. The challenge data is derived from a hash of the requested, fraudulent transaction information. In step 327, the MITM process 37 receives the transaction summary and challenge 235 and generates a modified transaction summary and challenge 270, as shown in FIG. 2C, by substituting back in the original customer transaction request details, so that the customer will remain unaware of any compromise in security, but keeping the fraudulent challenge data 296 “12340987”, so that the customer is able to generate a valid response to the fraudulent transaction request. Unaware of there being a problem, and on the basis of the modified request, the banking server 36 has no appreciation that “Fraudster” is not the desired recipient and, on the basis of the modified transaction summary and challenge 270, the customer has no appreciation that the banking server 36 is about to send money to “Fraudster” rather than to “David”. The transaction has thus been successfully subverted by the MITM process 37.

In step 330, the customer receives the modified transaction summary 270, now with the original transaction request details and the fraudulent challenge data, places the token reader 35 into C/R mode and, using the keypad of the token reader, enters the received challenge data 296. In response, in step 333, the token reader generates a response to the challenge and, in step 336, the customer submits the response to the banking server 36. The MITM process 37 receives the response and relays it to the banking server 36. In step 339, the banking server receives the response and, assuming that there are sufficient cleared funds and that the response is valid, which it will be since it was generated using two-factor authentication, executes the transaction to transfer 10,000 dollars to the bank account belonging to the fraudster. Finally, in step 341, the banking server sends a transaction receipt to the customer, which is intercepted by the MITM process 37 and relayed to the customer in step 343. Again, if the receipt includes a copy of the transaction details, the MITM 37 process substitutes back in the original customer transaction details, so that the customer remains unaware of the true transaction that has occurred.

The aforementioned MITM attack is extremely difficult to detect until a paper bank statement is received by the customer. In addition, since the bank records show that a genuine customer logged onto the bank using valid logon information generated by a two-factor authentication process and requested a transaction that was validated by the two-factor authentication process, it may be difficult for a customer to prove that they were not party to the fraudulent transaction that occurred.

It will be appreciated that the process described with reference to FIG. 3 is only one way in which a MITM attack can be perpetrated. Many variants or similar attacks are possible. For example, Trojan code on a customer PC may divert transmissions from the customer to a third party, fraudster computer, which is located physically at another location. In this case, the fraudster computer could act as the customer in transmissions with the bank, and forward subverted communications back to the customer. In some examples, the fraudster computer might even present itself to the customer as the bank. In general a MITM process might reside on a customer PC or on a third party PC, or be distributed between both a customer PC and a third party PC.

Aspects and embodiments of the present invention aim to increase the degree of security in online transactions.

### SUMMARY OF THE INVENTION

According to one aspect, the present invention provides an online transaction method enacted between a first party and a second party, including the steps of: the first party transmitting a transaction request comprising transaction details; and the second party receiving the transaction request and generating, for the first party, an authentication request, comprising transaction details and challenge data, wherein the authentication request is adapted so that it is difficult for an automated process to use or modify information therein to generate a replacement authentication request.

According to another aspect, the present invention provides an online transaction method, comprising a second party: receiving from a first party a transaction request comprising transaction details; generating challenge data; generating an authentication request comprising the transaction details and challenge data; and returning the authentication request to the first party, wherein the authentication request is adapted so that it is difficult for an automated process to use or modify information therein to generate a replacement authentication request.

According to a further aspect, the present invention provides an online transaction method, comprising a first party: generating a transaction request comprising transaction details; sending the transaction request to a second party; receiving an authentication request from second party, the authentication request comprising transaction details and challenge data; comparing the returned transaction details with the originally sent transaction details; if the two instances of the transaction details correspond, identifying and using the challenge data to generate a response and sending the response to the second party; and if the two instances of the transaction details do not correspond, not authenticating the transaction request, wherein the authentication request is adapted so that it is difficult for an automated process to use or modify information therein to generate a replacement authentication request.

By “difficult” we mean difficult in practical terms, for example within a reasonable amount of time, using a reasonable amount of computing power in the circumstances, or without leaving evidence of tampering, for an automated process, for example a MITM process executing on a PC or the like, to use information in the authentication request to generate, reconstruct or rebuild a replacement, fraudulent, authentication request.

In preferred embodiments, the authentication request is bound together so that it is difficult for an automated process to use or modify information therein to generate a replacement authentication request. The transaction details and the challenge data are preferably bound together in a way that renders it impractical for an automated process to use or change the information contained therein to generate a replacement authentication request. It is likely that such a secure binding would need to be strengthened over time as fraudsters and subversive automated processes become more intelligent and computing power for customer computers increases.

The first party could be a genuine customer or instead a MITM process or the like. Indeed, the second party is unlikely to know, at least initially, whether the first party is a genuine customer, a fraudster or a fraudulent process. The second party may be, for example, a service provider server, such as a banking server. Alternatively, the second party could be the server of any online store, broker or other organisation for which secure online transactions are important. For example, while a transaction might involve money, it may instead involve products or commodities that are bought, acquired or exchanged with or without money, or an agreement or contract of some kind between parties.

The challenge data may comprise at least some information that was previously unknown by the first party. For example, the challenge data may be derived from a hash of the transaction details, and so would appear to a customer to be an arbitrary and previously-unknowable 8-digit number.

An expected response to the challenge, to be generated using the challenge data, may comprise at least some information that was previously unknown by the first party. For example, the response might be generated using a token or token reader and would then appear to a customer to be an arbitrary and previously-unknowable 8-digit number.

The authentication request may be adapted so that it is difficult for an automated process to use or modify information therein to generate a replacement authentication request without it being evident that tampering had occurred. In addition, or alternatively, the authentication request may be adapted to be difficult for an automated process to read, separate the transaction details from the challenge data and/or identify, derive, extract, learn or distinguish between the challenge data and the transaction details.

In preferred embodiments the authentication request comprises image data. For example, the image data might be used instead of, or in addition to, text-based characters, which would be relatively more easily identified by a machine process. The image data might be arranged into a GIF, JPEG, BMP, PNG, TIFF or other known or devised image format. In other instances, the image data might relate to a moving image, such as a video, avatars or animated graphics, or even streaming text.

Accordingly, the transaction details and the challenge data may be embedded in the image data.

In some embodiments, the challenge data is arranged to be independently difficult for automated means to read. Instead, or in addition, the transaction details are arranged to be independently difficult for automated means to read.

The transaction details and the challenge data may be arranged in a manner which has the effect of making the authentication request difficult for automated means to read.

The authentication request may comprise a composite image incorporating the transaction details and the challenge data. The authentication request may comprise a superposition of the transaction details and the challenge data, wherein at least a portion of the transaction details appear to overlap with a portion of the challenge data. Then, an overlapping portion may be arranged so that respective features of both the transaction details and the challenge data are visible. In other words, an overlapping portion of either or both the transaction details and the challenge data may provide the appearance of being at least partially transparent. In this way, there would be evidence of tampering in a previously overlapping portion of either the transaction details or the challenge data if the other information had been replaced.

In some embodiments, the authentication request is multicoloured and/or multi-shaded. For example, different parts of the challenge may be rendered in different colours or shades of the same colour, or a combination of both. Some text may be arranged to appear in one colour and/or shade and other text may be arranged to appear in another colour and/or shade. Background and foreground portions of the challenge may in addition, or instead, be rendered in multiple colours and/or shades. Any practical combination of the foregoing colour and shade options is permissible. It is perceived that using different colours makes it more difficult for a machine to read and distinguish textual and numeric characters from each other and from background and foreground colours.

The authentication request may further comprise an image, which is recognised by a respective authentic transaction requester, onto at least a part of which is transposed the transaction details and/or the challenge data. For example, the image information might comprise a photograph, pattern or logo supplied by, or at least known to, a customer in advance of the transaction, and the customer might expect any authentication request to include the image. While it might be possible for an automated process to generate a fraudulent authentication request by using the image and by replacing the transaction information and/or the challenge data that had overlain the photograph, there would likely remain areas of the photograph that would be newly obscured or newly revealed. Since the automated process would not have access to the original image, it would not be able to fill-in the newly revealed areas of the photograph, and it would then most likely be evident to the customer that the authentication request had been tampered with.

Text used in the authentication request may comprise at least one of more than one font size, font style, font weight and font spacing. In addition, or alternatively, some text in the authentication request may be arranged to appear at different angles or orientations to other text. For example, some text may appear at oblique angles to other text, while other text might appear horizontally or vertically. Additionally, or alternatively, some textual words or numbers might have an orientation, or even a direction of flow, that varies from beginning to end. In any event, at least some text might appear in reverse.

The authentication request may comprise rendered data which embodies both the transaction details and the challenge data. The rendered data might comprise image data, sound data, voice data or a combination of any of the aforementioned kinds of data.

The authentication request might include one or more questions, statements or other indicia designed to reveal or elicit the challenge data. Accordingly, challenge data can be direct or indirect, implicit or explicit. For example, while challenge data could include a digit “2”, instead it could include a question such as “What is one plus one?”. Either way, a human user would understand that the challenge data is “2”. However, a machine process should have more difficulty extracting “2” from the question. Other indicia might include, for example, a picture or simple puzzle, the contents of or answer to which, respectively, provides the challenge data.

An online transaction method as described might include the step of generating synthesized voice data to form a part of the authentication request. For example, the synthesized voice data might represent at least a part of the authentication request information that is difficult for automated means to use. As such, embodiments of the present invention may find application for use with hearing impaired people or in other auditory, for example telephone-based, interactions. The voice data might be unadulterated or instead it might be distorted or modified in some way in order to make machine identification of the contents even more difficult. In other embodiments, the voice data might be mixed with or superimposed onto other sound, for example music which is known to the customer: it being difficult for a MITM process to separate the music from the voice data.

In any event, the request may be transmitted over a first communications medium and the challenge may be transmitted over a second communications medium. Additionally, a response to the challenge, which might be generated by a second party, might be returned to the first party using either the first or the second communications medium, or even yet another different communications channel or medium. As such, for example, if a MITM process were to compromise one channel, use of another channel could reveal the existence of, or even bypass, the threat. Then, the first communications medium may be terminated by a computing apparatus and the second communications medium may be terminated by a telephone apparatus or a PDA.

In one exemplary embodiment, the first communications medium is the Internet and the transaction request is received by a computer of the second party, and the second communications medium is a telephony network and the challenge is received by a telephone or a PDA. The telephone may, of course, be fixed or mobile and be capable of receiving voice, text and/or image-based messages.

According to a further aspect, the present invention provides an authentication request for use in a method according to any one of the preceding aspects of the present invention. Then the authentication request might comprise transaction details and challenge data, arranged in a manner that makes it difficult for an automated process to use information therein to generate a replacement authentication request.

According to a still further aspect, the present invention provides a system for online transaction processing, comprising first party equipment and second party equipment, in communication with each other via at least one communications channel, wherein the first party equipment is arranged to request a transaction, comprising transaction details, and the second party equipment is arranged to receive the request, generate and return an authentication request to the first party equipment, the authentication request comprising transaction details and challenge data and being adapted so that it is difficult for an automated process to use or modify information therein to generate a replacement authentication request.

Another aspect of the invention relates to a method of generating a challenge request for use in an online transaction, the method comprising forming a composite data arrangement containing data that can be presented to and recognized by a human recipient but which cannot be modified or replaced by automated means without such tampering being evident to the recipient

Other aspects and embodiments of the present invention relate to transaction server apparatus. Such apparatus might comprise the aforementioned second party equipment. Such apparatus might be adapted to enact the method steps of the second party as hereinbefore described. Other apparatus might be adapted to enact the method steps of the first party as hereinbefore described.

Either or both of the first party equipment and the second party equipment may comprise one or more kinds of apparatus, devices or data processing terminals.

Further aspects, embodiments, features and advantages of the present invention will become apparent from the following description of preferred embodiments of the invention, given by way of example only, which is made with reference to the accompanying drawings.

### BRIEF DESCRIPTION OF THE DRAWINGS

FIG. 1 is a diagram showing a known online transaction system and the steps involved in an exemplary transaction.

FIGS. 2A is an example of transaction summary and challenge information generated in an authentic transaction and FIGS. 2B and 2C are examples of transaction summary and challenge information generated in a fraudulent transaction, which might arise in the system of FIG. 1.

FIG. 3 is a diagram which shows a transaction system, which has been subverted by a man-in-the-middle process, and the steps involved in a subverted transaction.

FIG. 4 is a diagram which shows a transaction system, which has been subverted by a man-in-the-middle process, and the steps involved in a modified transaction according to an embodiment of the present invention.

FIGS. 5A and 5B are exemplary challenge images, which may be used in the system of FIG. 4.

FIG. 6 is a diagram representing the functionality of an exemplary banking server, which may be used in the system of FIG. 4.

FIG. 7 is a flow diagram showing a transaction process, according to an embodiment of the present invention, which is adapted to overcome a man-in-the-middle attack.

FIG. 8 is a diagram that illustrates an exemplary web page, which incorporates an authentication request according to an embodiment of the present invention.

FIG. 9 is an alternative embodiment of the present invention in which an authentication request is transmitted to a customer using an out-of-band message.

FIGS. 10A, 11A and 12A are CAPTCHA images.

FIGS. 10B, 11B and 12B are exemplary authentication requests, according to embodiments of the present invention, incorporating transaction details and respective CAPTCHA images of FIGS. 10A, 11A and 12A.

FIGS. 13A-13C are diagrams illustrating a further exemplary authentication request, which uses a photograph as a background image.

### DETAILED DESCRIPTION OF THE INVENTION

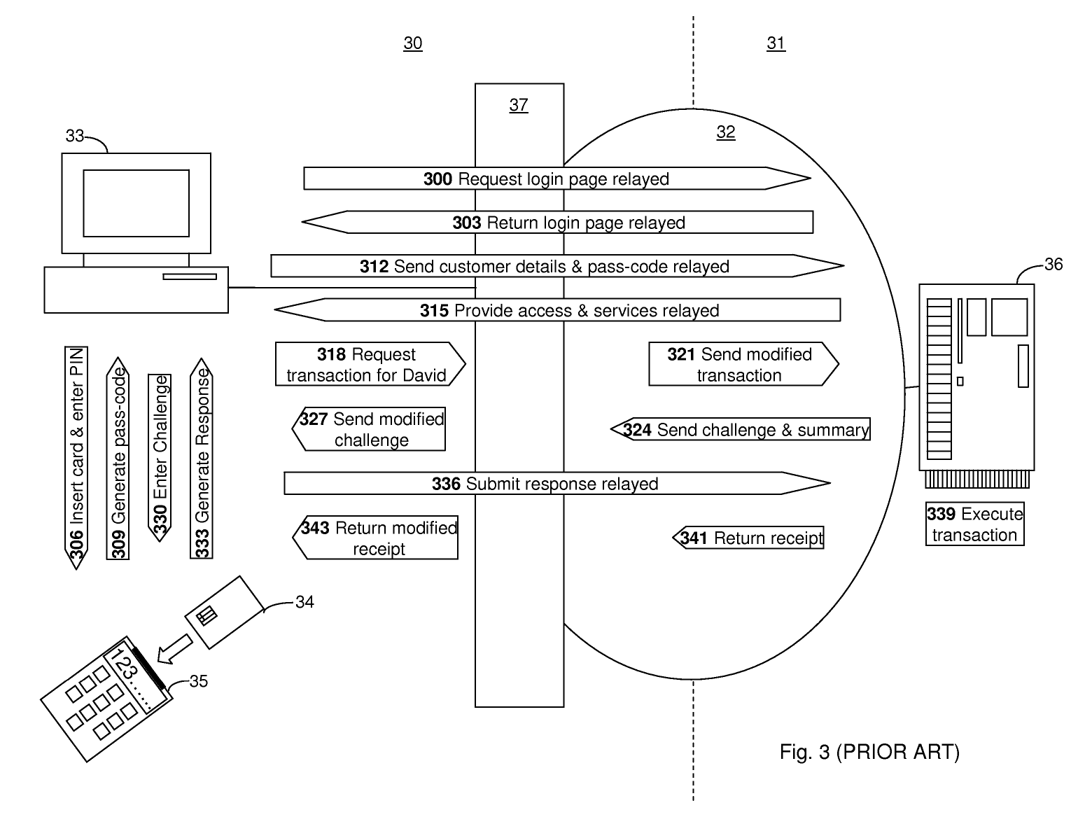

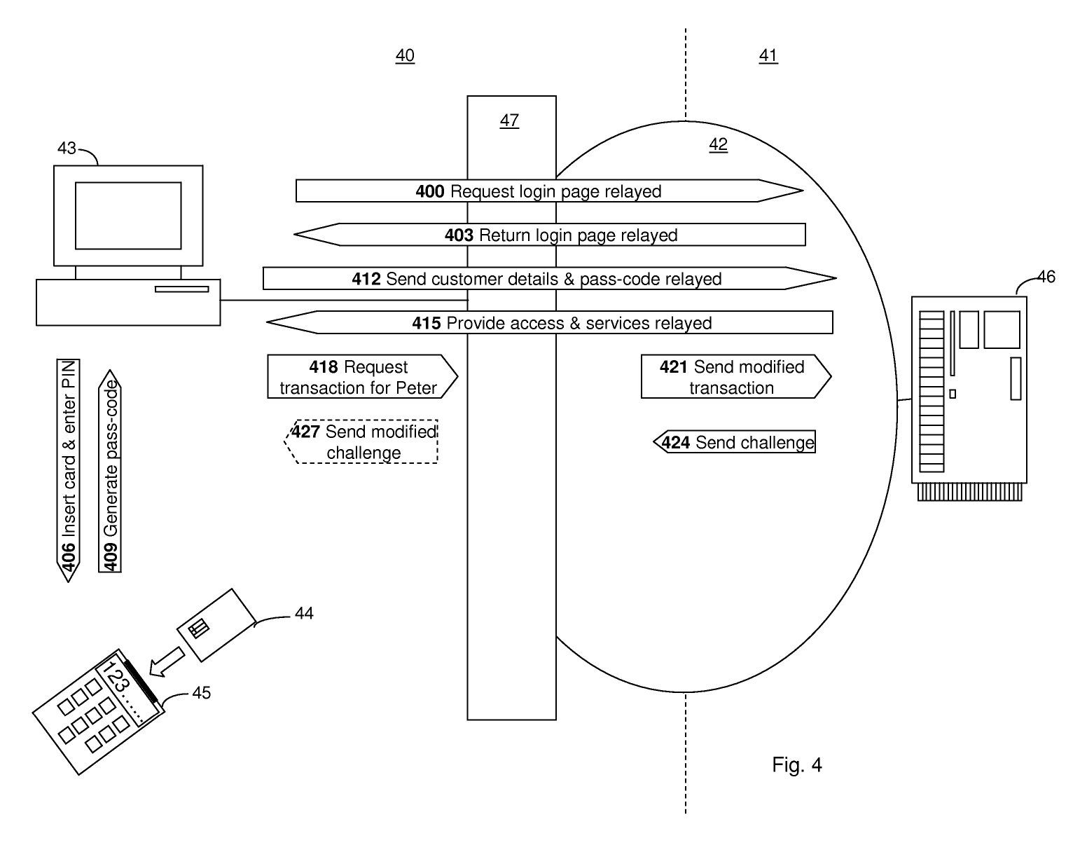

A preferred embodiment of the present invention will now be described with reference to the diagram in FIG. 4. FIG. 4 closely resembles FIG. 3 and equivalent components will not be described again. A key difference between the system in FIG. 3 and the system in FIG. 4 lies in how the banking server 46 processes a transaction request, which is received from either a customer or a MITM process 47, as will now be described with reference to the numbered process steps shown in FIG. 4.

In a first step 400, the customer transmits a request for the login page of their online bank website. The MITM process 47 intercepts and then relays the request to the banking server 46 as if the MITM process had made the request. In step 403, the banking server 46 returns the login page to the MITM process, which relays the login page to the customer. The customer, in step 406, inserts his token 44 into the token reader 45, places the token reader in login mode and, using a numeric keypad of the reader, enters a PIN number. In response, in step 409, the reader generates a unique pass-code. In step 412, the customer enters their customer identification details and the unique pass-code into the login page and submits the login page to the banking server 46. Again, the MITM process intercepts and then relays the login information to the banking server 46 as if the MITM process 47 were the customer. In response, assuming the information is verified by the banking server 46, in step 415 the banking server provides access to, and services associated with, bank accounts registered to the customer. In effect, the MITM process 47 simply relays respective web pages to the customer.

In step 418, the customer generates and sends a transaction request to transfer 300 dollars to a friend, Peter. The MITM process 47 intercepts the request and, in step 421, modifies the request by substituting new recipient and amount details in place of the genuine details, and forwards on the modified request to the banking server 46. For example the modified request might be to send 10,000 dollars to a bank account from where, ultimately, the funds can be withdrawn by the fraudster. In step 424, the banking server receives the modified request and, in order to validate the request, sends a transaction summary and challenge to the customer to, again, verify that the party requesting the transaction is the customer and not someone who has intervened in or ‘hijacked’ the transaction after the customer had logged in.

Up until this point in the process, it will be appreciated that generally the same steps have occurred as were described up to the same point in FIG. 3. At this point, however, according to an embodiment of the present invention, the banking server 46 generates a transaction summary and challenge, which cannot in practical terms be manipulated by the MITM process 47.

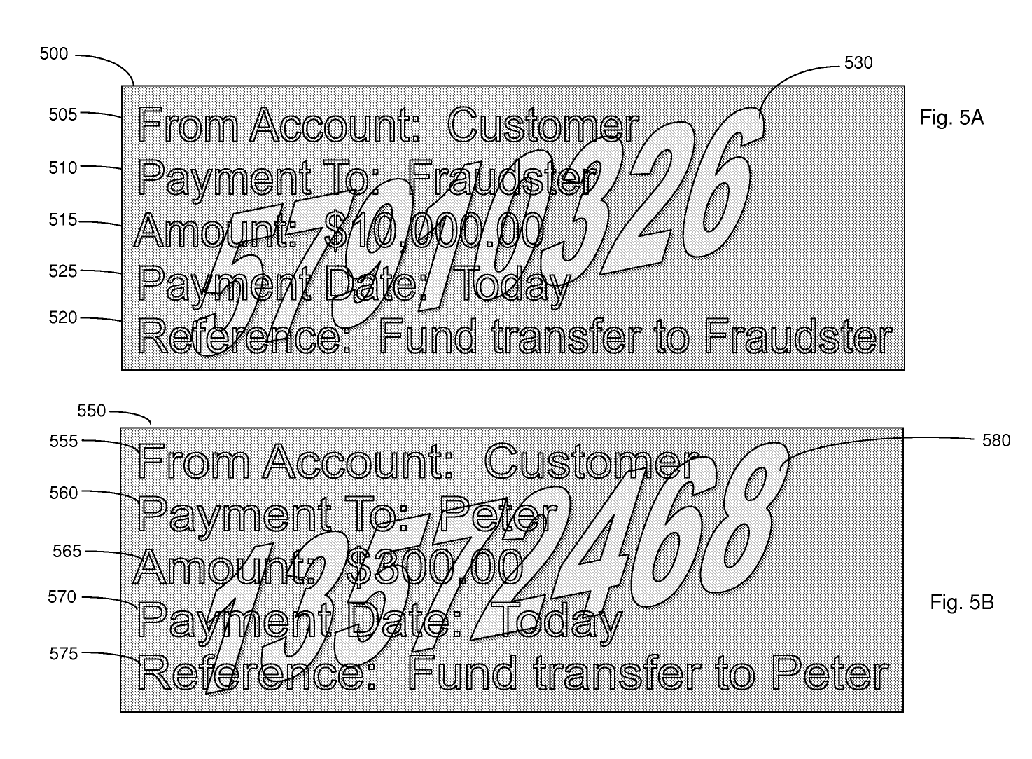

In a preferred embodiment, the challenge comprises an image file, which contains information relating to the transaction request and challenge data; in this case both provided by the MITM process 47. An exemplary image file is illustrated in the diagram in FIG. 5A.

As shown, the image file 500 contains information relating to the transaction request in the form of several data fields: namely, an account 505 “Customer” from where funds should be taken, a payee “Fraudster” 510; an amount “$10,000” 515 of funds to be transferred, a customer reference “Fund transfer to Fraudster” 520; and a transfer date “Today” 525. These data fields are in themselves relatively standard insofar as any typical online transaction request requires the data. In addition to the data fields, challenge data is included in the image 500 in the form of an eight digit challenge 530, “57910326”, which is superimposed diagonally, in a large and stylised font, across the aforementioned data fields. This is the challenge data that a customer is expected to use, for example in association with their token and token reader arrangement, in order to generate a valid response.

It will be appreciated that the challenge illustrated in FIG. 5A is difficult for a machine to process. In particular, the challenge data interferes or interacts visually with the representation of the transaction details, so that a MITM process would find it non-trivial to extract and replace the transaction details. At the same time, a human can relatively easily differentiate between the transaction details and the challenge data.

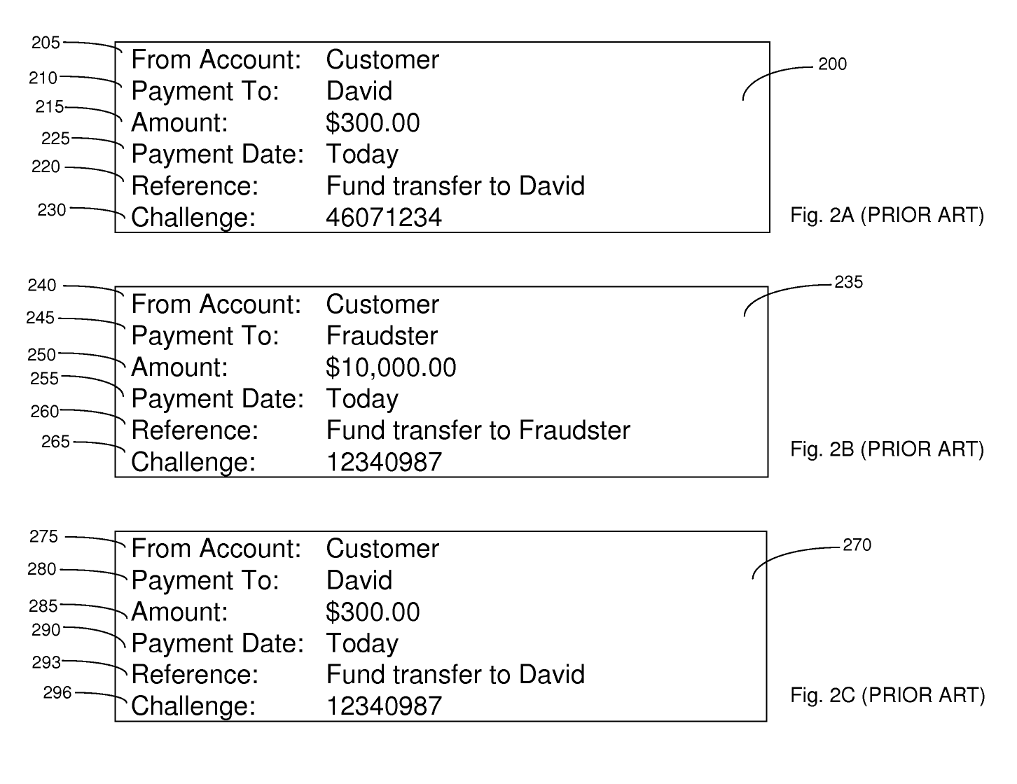

By way of comparison, it would be relatively easy for a MITM process to identify the transaction details in the challenge shown in FIG. 2A, especially if the transaction details and challenge data were provided in plain text in a web page. Even if the challenge of FIG. 2A were a rendered image, such as a GIF or a bitmap, rather than a text-based representation, it would not be difficult for a MITM process to use a known optical character recognition (OCR) algorithm to extract the relevant transaction information and replace it with fraudulent transaction information.

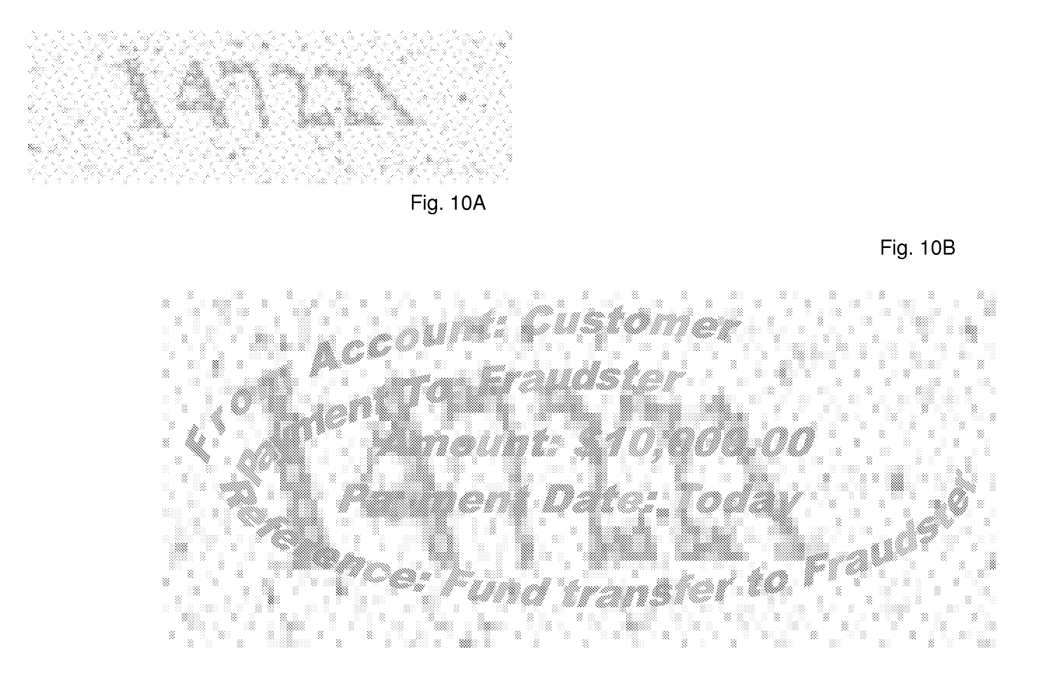

In practical embodiments, the transaction summary and challenge would typically contain multiple colours and shades, and possibly include additional background and foreground patterns that would make it even more difficult for a MITM process to subvert. Indeed, background or foreground patterns could include a company logo or the like or even a photograph, for example of a relative of or a pet belonging to the customer, which was provided by the customer when they originally signed up for the service. Of course, it is not possible herein to reproduce a multi-coloured transaction summary and challenge. However, on the basis of the present description, the skilled person would be able through experimentation to use such principles to generate a form of transaction summary and challenge that can be understood by a human but appear incomprehensible to a computer. Additional examples of transaction summaries that are difficult for a machine to process are provided in FIGS. 10 to 13 and will be discussed hereinafter.

As shown, the data fields in the image file contain data in the transaction request that was transmitted to the banking server in step 421. This is because, as far as the banking server is concerned, the modified transaction request is a valid request from the customer.

At this point, in order for the MITM process 47 to continue to subvert the transaction process, it would have to be able to receive the image file 500, separate the challenge data 530 from the transaction details 505-525 in real time—by which we mean before a customer becomes suspicious because of an extended delay—and then generate a new image file containing the same challenge with the original customer transaction request details. This sequence of steps would be non-trivial, though not impossible, even for a powerful computer running sophisticated image recognition software. On the basis that the image 500 is designed to be difficult for any MITM process 47 to modify in real time, in effect, the transaction process probably comes to a halt at step 424 and the customer is unable to complete the transaction. Thus, neither the customer nor the bank loses money. Alternatively, if the process continues, in step 427, with the MITM process 47 passing an unmodified image file 500 to the customer, the customer is alerted, by viewing the data fields, that the transaction request that the banking server 46 intends to execute is fraudulent. As another alternative next step, the MITM process might succeed in modifying the image. However, in this case, it is most likely that the resulting image would look like it had been tampered with, again alerting the customer. At this point, it is anticipated that the customer would discontinue using the transaction system and take steps to remove the MITM process 47, for example by using up-to-date virus protection and removal software.

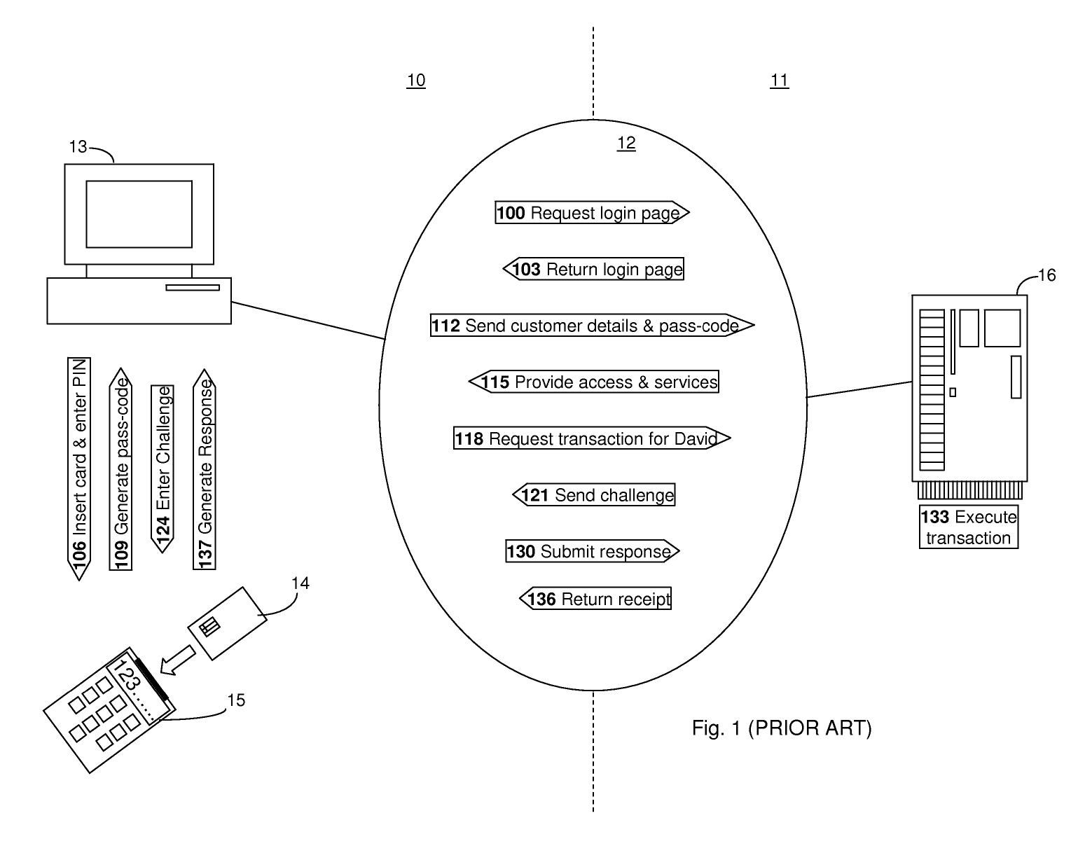

An example of an authentication request that the customer would expect to receive, in a non-subverted system, is illustrated in FIG. 5B. In this case, the payee 560 “Peter” and the amount 565 “$300” are correct. It should also be noted that the challenge data 580 “13572468”, which is derived from a hash of the valid transaction request information, is different from the challenge data 530 in FIG. 5A. The customer would be comfortable using this challenge as the basis for generating a response and the process would continue, as generally described with reference to steps 124 onwards in FIG. 1.

As described, it is clear that the preferred embodiment of the present invention depends on two factors: (1) an image file, which is a combination or composite of both the transaction details and the challenge; and (2) it being difficult by automated means to extract and distinguish between the transaction details and the challenge data. While certain prior art may have adopted the first factor, of combining the two sets of information into an authentication request, none of the prior art known to the present applicants has adopted the second factor in order to overcome a MITM attack.

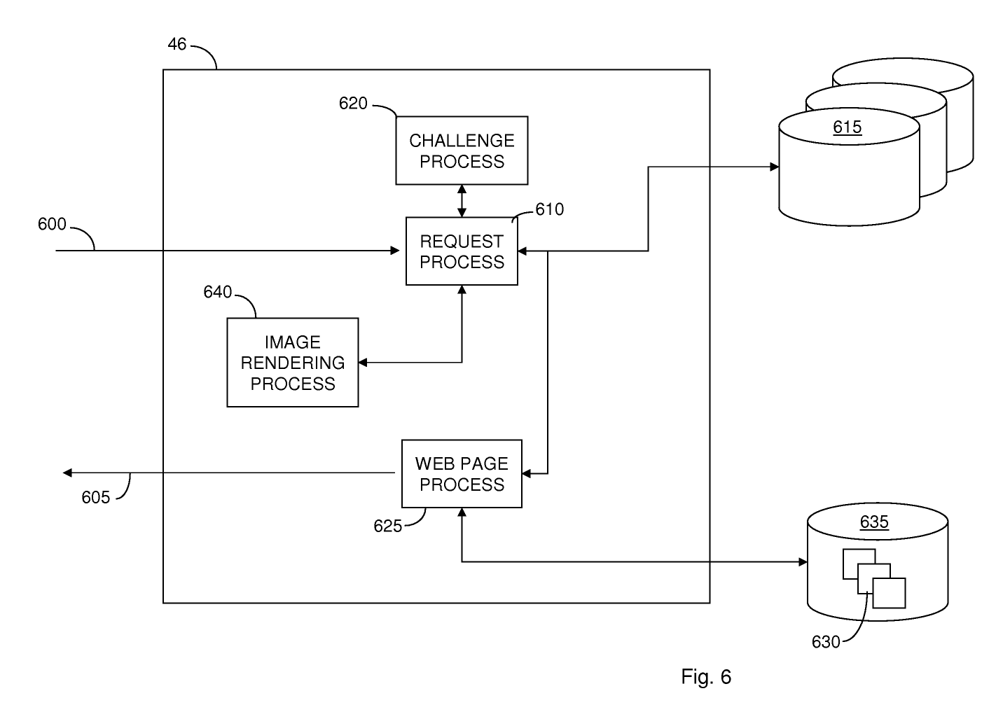

A banking server 46 suitable for use in the foregoing preferred embodiment will now be described in more detail with reference to the block diagram in FIG. 6. As shown, the banking server 46 comprises an input 600 for receiving information and web page requests from a customer, an output 605 for delivering or serving web pages to a customer, a request process 610 for processing requests from a customer, one or more databases 615 containing customer account details including login details, a challenge process 620, a web page process 625 for generating web pages, using input data received from the request process 610 and standard page templates 630, which are stored in a template database 635, and an image rendering process 640, for generating challenge image files.

The banking server 46 itself typically comprises a standalone computer, server or a cluster of computers or servers on which banking server applications and processes can be executed. Such computers and servers may be supplied by SUN™, IBM™ or Hewlett-Packard™ and run appropriate operating system and application software.

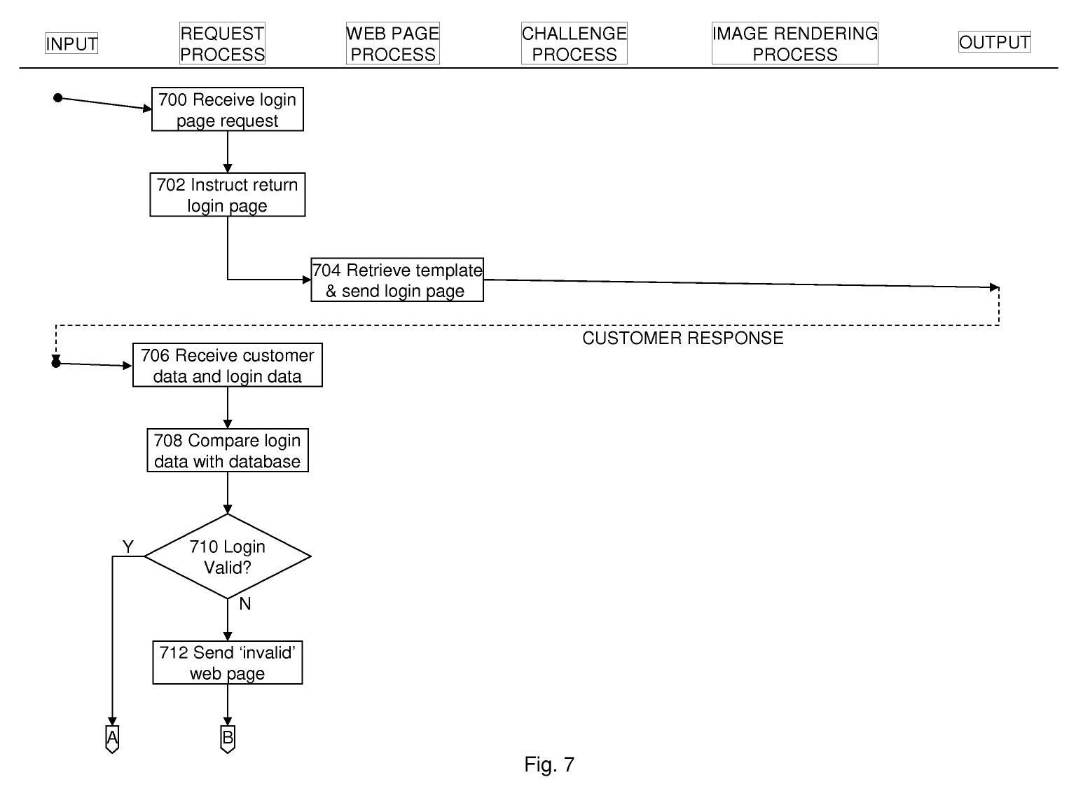

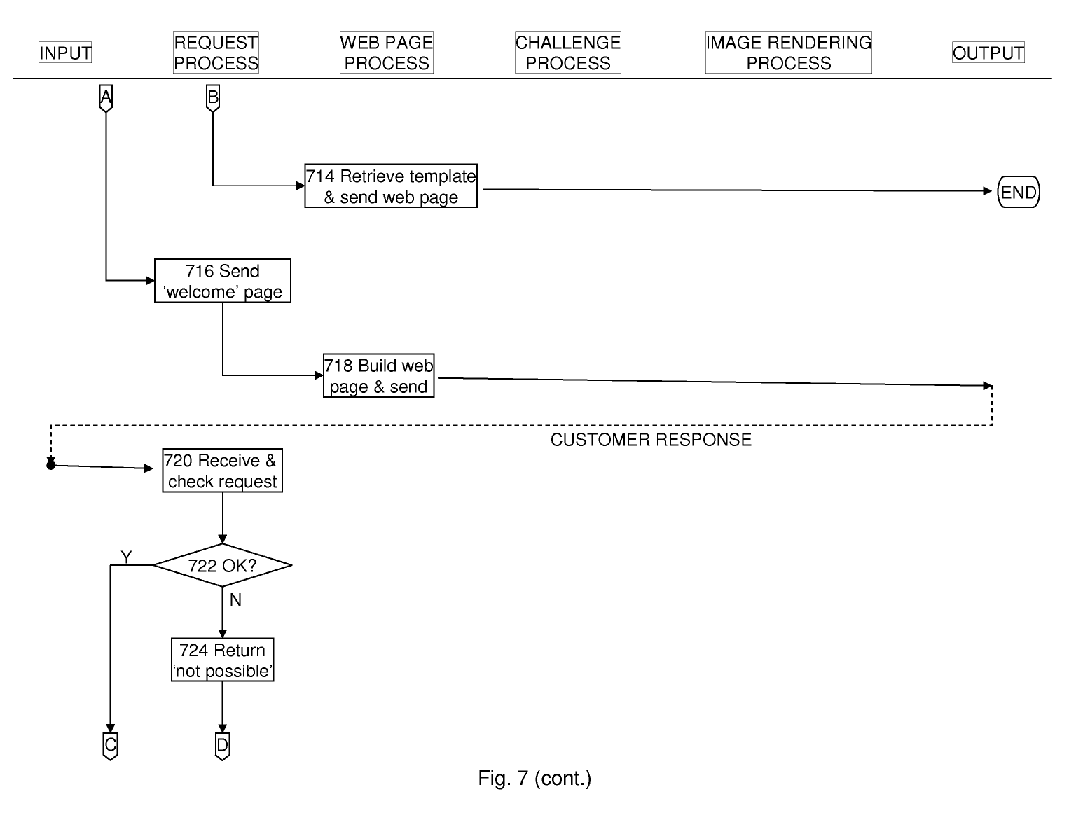

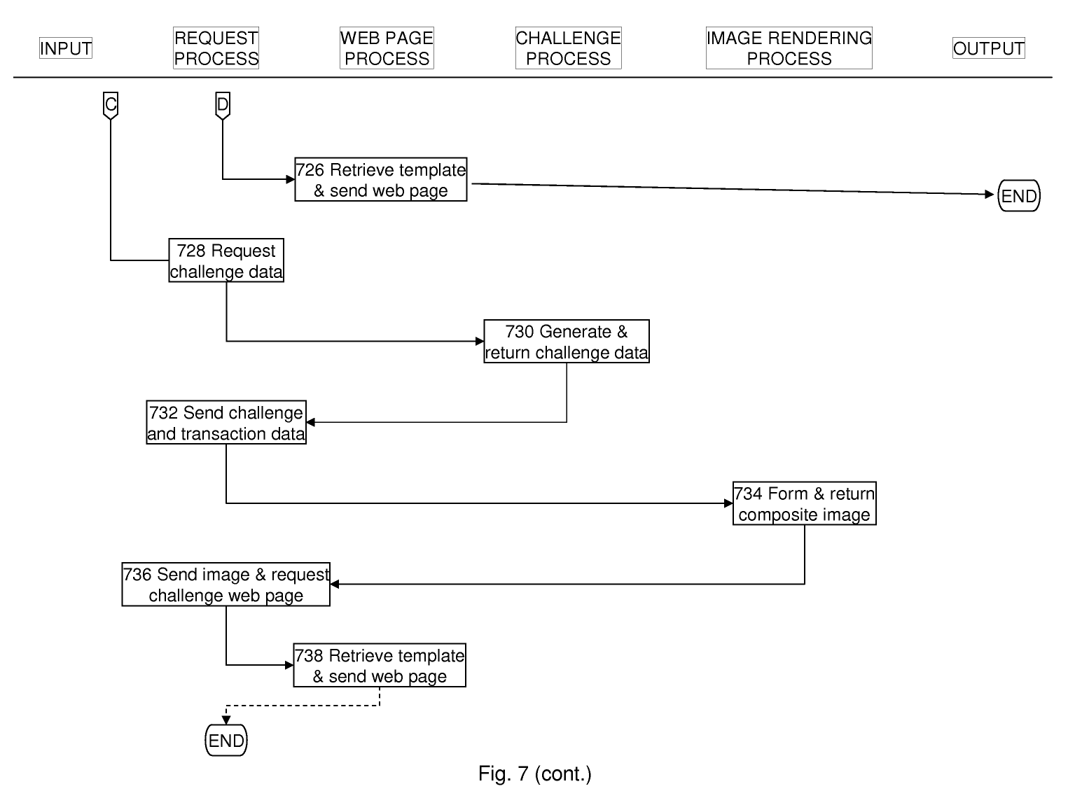

The operation of the banking server will now be described in more detail with reference to the flow diagram in FIG. 7. In a first step 700 the request process 610 of the banking server 46 receives a request from a customer to return a login page. In step 702, the request process 610 instructs the web page process to return the login page to the customer. In step 704, the web page process retrieves a login page template from the template database 635 and returns the login page to the customer. In step 706, the request process 610 receives a customer identity and respective login data from the customer. In step 708, the request process compares the customer identity and login data with valid login data, which is recalculated from information held in an appropriate database. The request process determines if the login request is valid in step 710 and, if not, instructs the web page process to send an appropriate message to the customer in step 712, the web page process retrieves an appropriate template and sends a respective page to the customer in step 714 and the process ends. If the login request is valid, then in step 716 the request process instructs the web page process 625 to send a “Welcome” page and main menu web page to the customer. In step 718, the webpage process 625 builds a web page appropriate for the customer using information from the request process 610 and standard templates 630 from the template database 635 and sends the welcome page to the customer.

At this point, the customer may make various standard account requests (not illustrated), such as banking statement downloads or balance reviews.

In step 720, the request process 610 receives a transaction request from the customer and checks with the appropriate database 615 to see if the transaction request is executable, for example by checking whether the customer has the required cleared funds. If, in step 722, the transaction is not executable, in step 724, the request process instructs the web page process to return a “Transaction not possible” web page to the customer. The web page process retrieves the appropriate web page template 630 from the template database 635 in step 726 and returns the web page to the customer, and the process ends. If the transaction is executable, in step 728 the request process 610 requests the challenge process 620 to generate challenge data, for example comprising a sequence of eight digits. The sequence of digits may be a random number, or a hash derived from the transaction information, generated by the challenge process 620. In step 730, the challenge process 620 returns the challenge data. In step 732, the request process 610 sends details of the transaction and the challenge data to the image rendering process 640. In step 734, the image rendering process 640 forms a composite image 500 containing both the transaction details and the challenge data and returns the image to the request process 610. Many known techniques are available for this rendering task. For example, the image rendering process may generate a simple GIF image file into which both sets of information are arranged. Many other file formats are possible, for example JPEG, BMP, TIFF or PNG. The composition of the rendered image file is described in more detail hereinafter.

In step 736, the request process forwards the image to the web page process 625 and requests that the image should be included in a challenge web page for sending to the customer. The web page process in step 738 retrieves an appropriate challenge web page template 630 from the template database 635, generates a challenge web page incorporating the rendered image file and sends the web page to the customer (or a MITM process which is pretending to be the customer).

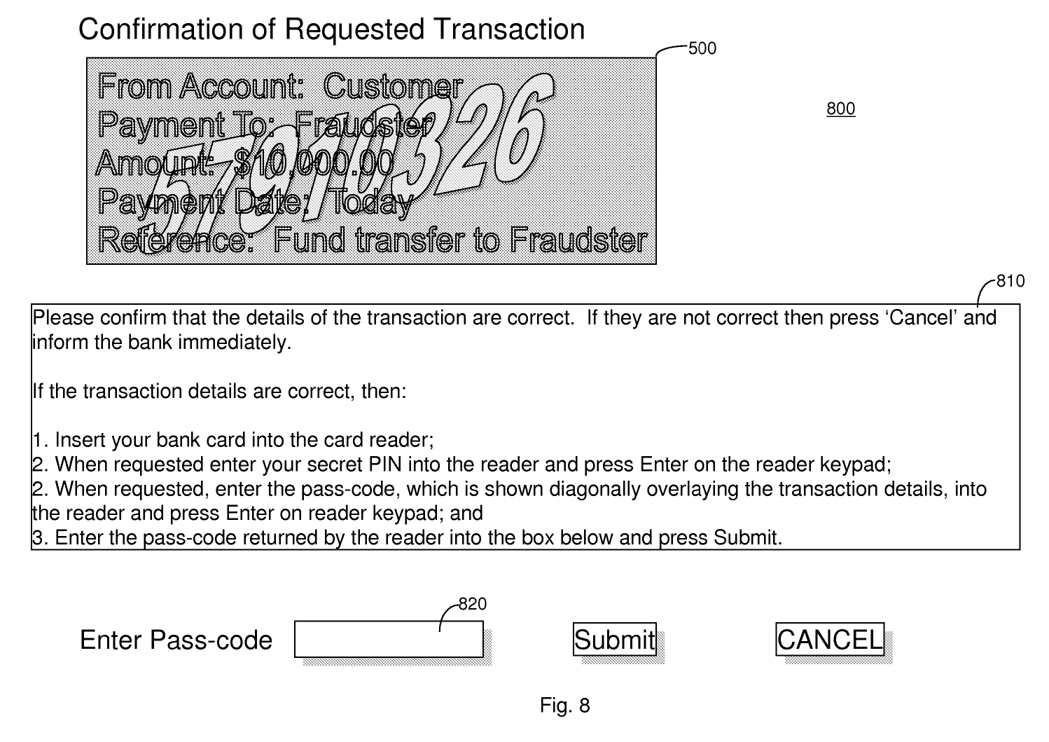

As shown in the diagram in FIG. 8, a challenge web page 800 includes transaction summary and challenge data in the form of the composite image 500 of FIG. 5 and instructions 810 on how to respond to the challenge or report any suspected fraud. In this exemplary web page 800, the challenge data is clearly fraudulent, and the customer would immediately recognize this, ‘Cancel’ the transaction and inform the bank, as instructed by the web page. The web page 800 also includes a text entry box 820 into which the customer would (if they received a non-fraudulent web page) enter a pass-code; that is, the response generated, for example, using a token and token reader. As already explained, the customer would use the challenge data, which is easily drivable by a human but not by a computer, from the challenge image portion 500 of the web page, as an input into a token reader or the like, which in turn would be used to generate the response.

Of course, at this point, if as described above the transaction has been subverted by a MITM process, the likelihood is that either the MITM process with stall, since it is unable to subvert the challenge, or the user will realise from receiving the wrong, or obviously tampered with, transaction data that the transaction has been subverted. In either case, the transaction is likely to end without any further communications reaching the banking server. Thus, if there is no response from the customer within a predetermined timeout period, the banking server deletes any state information relating to the transaction that it has accumulated up to that point in the transaction. In other words, the transaction has ended without being executed. The request process may log the failed transaction attempt since this information might be useful in any downstream audit or fraud investigation.

If, however, the transaction has not been subverted, the banking server 46 completes the process. In particular, if the banking server 46 receives a response, the request process 610 forwards the respective response data to the challenge process 620 and the challenge process determines whether the response is valid. If the response is not valid the request process 610 instructs the web page process 625 to send an appropriate web page to the customer and the web page process selects an appropriate template 630 from the template database 635 and returns an appropriate web page to the customer. If the challenge process 620 determines that the response is valid, the request process 610 executes the transaction and modifies the customer account details in the appropriate database 615. Then, the request process 610 instructs the web page process 625 to send a transaction receipt to the customer. In response, the web page process 625 selects an appropriate template 630 from the template database 635, builds the appropriate web page using information from the request process and sends the receipt to the customer. Finally, the process ends.

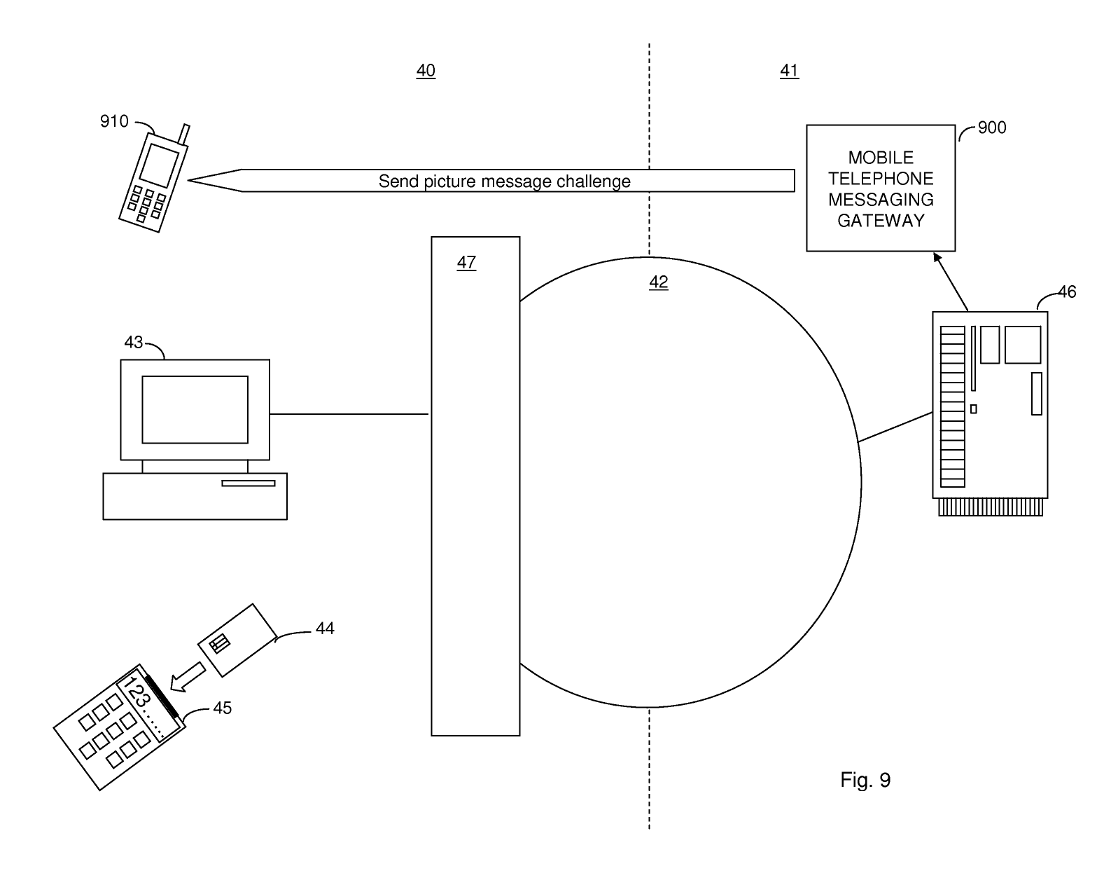

An alternative embodiment of the present invention is illustrated in the system diagram in FIG. 9. Many of the components in FIG. 9 are the same as those in FIG. 4, and their operation will not be described again. Additional components in FIG. 9 include a mobile telephone messaging gateway 900 and a mobile telephone 910, which belongs to the customer. The mobile telephone number of the mobile telephone 910 is registered with the bank when the customer signs up for online banking. In operation, the image rendering process 640 of FIG. 6 is adapted to generate a composite image as before but in a format suitable for viewing as a picture message on a compatible mobile telephone or PDA. Then, the request process directs the image, accompanied by mobile telephone number information for a respective customer, to the mobile telephone messaging gateway 900. The mobile telephone messaging gateway 900, in response, transmits the picture message in an appropriate format, for example as an SMS or USSD formatted message, to the mobile telephone 910 or PDA. The customer, in response, can use the received challenge data to generate a response in the usual way and return the response, via the PC 43, to the banking server 46. In essence, by sending an out-of-band challenge, for example via a different channel, communications link or network, which bypasses any MITM process 47 on the PC or elsewhere, the banking server 46 and the customer can have greater assurance that the challenge and the transaction details are genuine. In addition, the banking server 46 could still send the normal, in-band transaction summary and challenge to the PC, in which case a customer would be able to compare the details received by the mobile telephone or PDA with the transaction summary and challenge received by the PC. If the information received via different routes is not the same, this would alert the user to the presence of a MITM process or similar threat.

A further embodiment of the present invention relates to a system, similar to the one in FIG. 4, in which the banking server includes a sound rendering device instead of or in addition to the image rendering device 640. The sound rendering device has an analogous function to the image rendering device 640 apart from it generating a sound clip, which contains synthesized voice data, which when replayed is representative of both the transaction request information and the challenge data. This embodiment is particularly useful for hearing impaired customers, but the application is certainly not intended to be limited only to use with hearing impaired customers. For example, a synthesized voice challenge would be suitable for sending to a telephone, for receipt by anyone, or to a PC for playback via standard (or specially adapted) sound reproduction software.

In the case where a transaction summary and challenge is rendered as a sound clip file, which is transferred to the PC, it may still be possible for an adapted MITM process to apply voice recognition techniques to the sound file and subvert the clip by substituting fraudulent sound clip data into the file. In order to make this task more difficult, the sound clip may comprise distorted voice data, which cannot be readily processed by the MITM process. Either or both of the voiced words associated with the transaction details and the challenge data may be distorted. Distortion of many different forms may be applied to the words. For example, the words may be modulated using a cadence, echoes may be added to the words or the words may be spoken without discernable gaps between them. Many other ways of obscuring or distorting the words may be applied or devised. In each case, the words would still be relatively easily recognized by a human but difficult for a machine process to understand and process.

It is expected that some embodiments of the present invention may be able to adapt and use formulations that are published in association with the CAPTCHA programme. CAPTCHA stands for “Completely Automated Public Turing Test to Tell Computers and Humans Apart” and CAPTCHA principles are described concisely in an article “Telling Humans and Computers Apart Automatically”, by Luis von Ahn, Manuel Blum and John Langford in Communications of the ACM, February 3004, vol. 57, no. 3. So-called CAPTCHAs have been used in several known applications, which relate to proving a respondent is a human and not a computer program (bot), including preventing bots from making repeated, automated votes in online polls and preventing bots from registering thousands of bogus, free online email accounts. CAPTCHA principles are classified in three broad categories: (1) images that are difficult for machines to recognize (e.g. Gimpy); (2) information that can be elicited using questions or puzzles that are relatively easy for a user to solve but difficult for a machine to solve (e.g. Bongo, PIX); and (3) distorted synthesized words. All three principles find application in various embodiments of the present invention.

While CAPTCHA principles are not concerned with binding a challenge to transaction information, which is a key aspect of preferred embodiments of the present invention, it is anticipated that some embodiments of the present invention should be able to adapt and use the general style or format of newly-devised, and increasingly secure, CAPTCHAs and replace older styles, formulations or formats that have been shown to be susceptible to subversion by computer based attacks.

For example, embodiments of the present invention can apply the principles of CAPTCHA to obscure from a MITM process the content of transaction and challenge data.

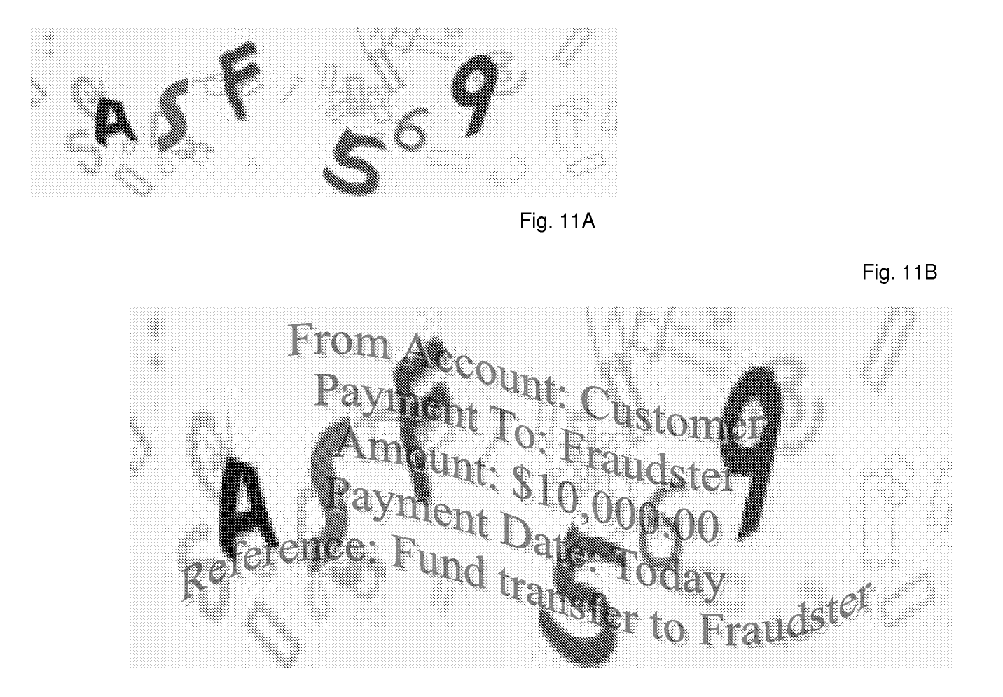

FIGS. 10A, 11A and 12A are known CAPTCHA images, wherein FIG. 10A is an obscured number “147221”, FIG. 11A is an obscured alphanumeric string “ASF569” and FIG. 12A is another obscured number “6999T”. FIGS. 10B, 11B and 12B each illustrate an authentication request, adapted from the respective CAPTCHA formulations, according to exemplary embodiments of the present invention. The images incorporate a respective CAPTCHA image from FIGS. 10A, 11A and 12A, which represents the exemplary challenge data, and the details of an exemplary transaction. In each example, the transaction details are superimposed onto the CAPTCHA image (or visa versa) in a way which makes it difficult for a machine process, for example a MITM process, to separate the CAPTCHA image from the transaction details. It is perceived to be beneficial in some embodiments to arrange for either or both of the fonts of the challenge data and the transaction information to appear semi-transparent. In this way, even if it proves possible to separate the two image portions and combine, say, (different) authentic transaction information with (existing) fraudulent challenge data, the challenge data would shown signs, for example in the form of darkened or lightened ‘overlap’ regions 1205 where it had previously overlapped with fraudulent transaction information, that the image had been tampered with.

Of course, it would be feasible to represent transaction details using a CAPTCHA formulation instead of, or in addition to, representing the challenge data as a CAPTCHA formulation.

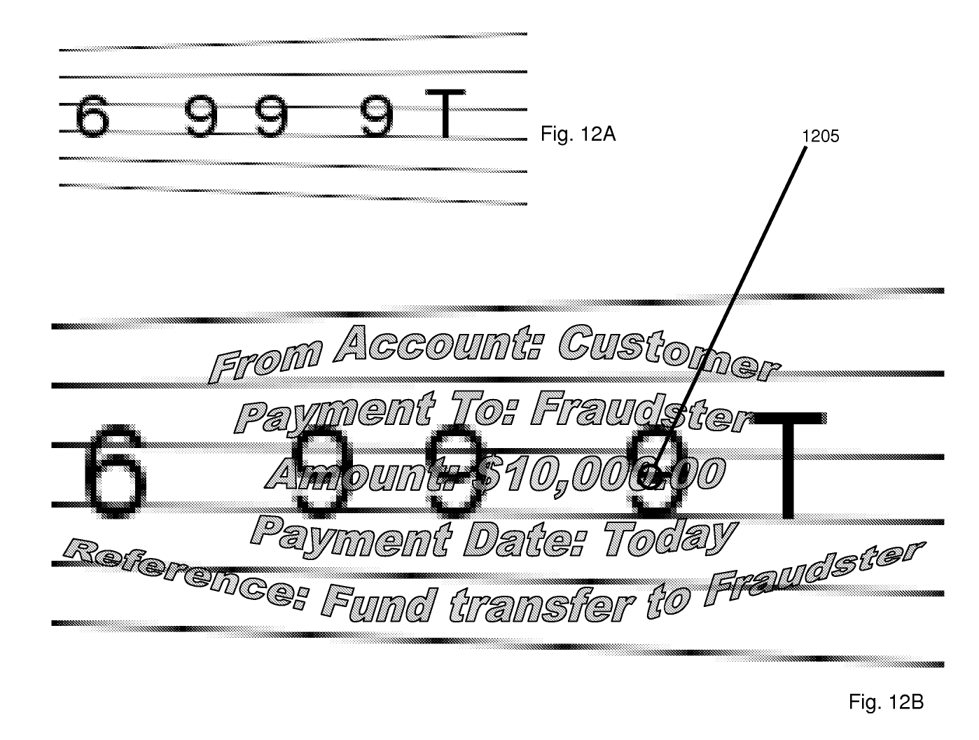

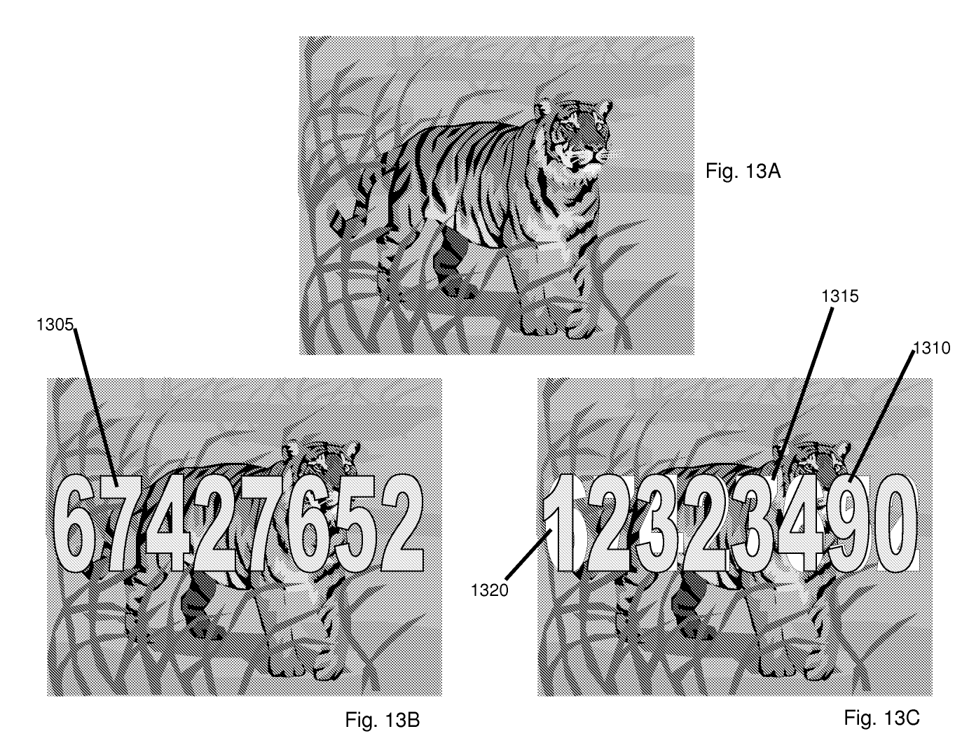

The picture in FIG. 13A is intended to be illustrative of a photograph of a animal, such as a family pet belonging to a customer. The photograph may be adapted for use according to embodiments of the present invention and may have been supplied to the bank by a respective customer when registering for the on-line service. The diagram in FIG. 13B illustrates exemplary challenge data 1305 “67427652”, according to embodiments of the present invention, which has been superimposed onto the photograph of FIG. 13A. FIG. 13B is intended to represent only a portion of an image comprising a transaction summary and challenge data. The diagram in FIG. 13C shows how the image might appear if it has been tampered with. In this case, it is clear that a MITM process, or the like, has managed to substitute in new challenge data 1310 “12323490”, by separating the original challenge data 1305 from the photograph. However, it evident that it would be possible for a user to see remnants, for example 1315 and 1320, of the original challenge data. The reason remnants of the original challenge data are visible is because the MITM process has no way of knowing how to fill in the gaps that are left when the original challenge is removed and the new challenge is added. Thus, a customer likely can identify a subverted challenge summary, according to certain embodiments of the present invention, even if a MITM process has been able to separate and replace a portion (or portions) of the summary.

The above embodiments are to be understood as illustrative examples of the invention. Further embodiments of the invention are envisaged. For example, an authentication request may comprise a combination of distorted or undistorted images and/or voiced words and may be forwarded to a customer via an Internet connection, via a telephone (fixed or mobile) or even via a terrestrial, satellite or cable television infrastructure, wherein any one of these infrastructures is classed herein as “online”. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An online transaction method enacted between a first party and a second party, including the steps of:
the first party transmitting a transaction request comprising transaction details; and
the second party receiving the transaction request and generating, for the first party, an authentication request, comprising transaction details and challenge data,
wherein the authentication request is adapted so that it is difficult for an automated process to use or modify information therein to generate a replacement authentication request.

2. An online transaction method according to claim 1, wherein the authentication request is bound together so that it is difficult for an automated process to use or modify information therein to generate a replacement authentication request.

3. An online transaction method according to claim 1, wherein the challenge data comprises at least some information that was previously unknown by the first party.

4. An online transaction method according to claim 1, wherein an expected response, to be generated using the challenge data, comprises at least some information that was previously unknown by the first party.

5. An online transaction method according to claim 1, wherein the authentication request is adapted so that it is difficult for an automated process to use or modify information therein to generate a replacement authentication request without it being evident that tampering had occurred.

6. An online transaction method according to claim 1, wherein the authentication request is adapted to be difficult for an automated process to read.

7. An online transaction method according to claim 1, wherein the authentication request is adapted so that it is difficult for an automated process to separate the transaction details from the challenge data.

8. An online transaction method according to claim 1, wherein the authentication request comprises image data.

9. An online transaction method according to claim 8, wherein the transaction details and the challenge data are embedded in the image data.

10. An online transaction method according to claim 1, wherein the challenge data is arranged to be independently difficult for automated means to read.

11. An online transaction method according to claim 1, wherein the transaction details are arranged to be independently difficult for automated means to read.

12. An online transaction method according to claim 1, wherein the transaction details and the challenge data are arranged in a manner which has the effect of making the authentication request difficult for automated means to read.

13. An online transaction method according to claim 1, wherein the authentication request comprises a composite image incorporating the transaction details and the challenge data.

14. An online transaction method according to claim 1, wherein the authentication request comprises a superposition of the transaction details and the challenge data, wherein at least a portion of the transaction details appear to overlap with a portion of the challenge data.

15. An online transaction method according to claim 14, wherein, an overlapping portion is arranged so that respective features of both the transaction details and the challenge data are visible.

16. An online transaction method according to claim 1, wherein the authentication request is multicoloured and/or multi-shaded.

17. An online transaction method according to claim 1, wherein the authentication request further comprises an image, which is recognised by a respective authentic transaction requester, onto at least a part of which is transposed the transaction details and/or the challenge data.

18. An online transaction method according to claim 1, wherein text used in the authentication request comprises at least one of more than one font size, font style, font weight and font spacing.

19. An online transaction method according to claim 1, wherein some text in the authentication request is arranged to appear at different angles or orientations to other text.

20. An online transaction method according to claim 1, wherein the authentication request comprises rendered data which embodies both the transaction details and the challenge data.

21. An online transaction method according to claim 1, wherein the authentication request includes one or more questions, statements or other indicia designed to reveal or elicit the challenge data.

22. An online transaction method according to claim 1, including the step of generating synthesized voice data to form a part of the authentication request.

23. An online transaction method according to claim 1, wherein the request is transmitted over a first communications medium and the challenge is transmitted over a second communications medium.

24. An online transaction method according to claim 23, wherein the first communications medium is terminated by a computing apparatus and the second communications medium is terminated by a telephone apparatus or a PDA.

25. A system for online transaction processing, comprising first party equipment and second party equipment, in communication with each other via at least one communications channel, wherein the first party equipment is arranged to request a transaction, comprising transaction details, and the second party equipment is arranged to receive the request, generate and return an authentication request to the first party equipment, the authentication request comprising transaction details and challenge data and being adapted so that it is difficult for an automated process to use or modify information therein to generate a replacement authentication request.

26. A transaction processing system comprising first processing means and second processing means, which can communicate with one another via at least one communications channel, wherein the first processing means has means for generating and requesting a transaction, comprising transaction details, and the second processing means has means for receiving the request, and means for generating an authentication request and means for forwarding the request to the first processing means, wherein the authentication request comprises transaction details and challenge data and is adapted so that it is difficult for an automated process to use or modify information therein to generate a replacement authentication request.
